(19) United States
(12) Patent Application Publication
(10) Pub. No.: US 2007/0047223 A1
(43) Pub. Date: Mar. 1, 2007

(54) Finger light

(76) Inventors: Sudhir Kumar Mundhra, Cerritos, CA (US); Sadhana Mundhra, Cerritos, CA (US)

Correspondence Address: CISLO & THOMAS, LLP, 233 WILSHIRE BLVD, SUITE 900, SANTA MONICA, CA, 90401-1211, US

(21) Appl. No.: 11/213,280

(22) Filed: Aug. 26, 2005

(51) Int. Cl. F21V 21/08; F21L 4/00

(52) U.S. Cl. 362/103; 362/190

(57) ABSTRACT

A finger light provides local illumination adjacent to a user's finger during a writing activity. Using a housing having a switchable light source and a finger-engaging framework removably coupled to the housing, a finger light is provided that enables local illumination for the user in a discreet or focused manner. In an alternative embodiment, a magnifying lens chassis is operatively coupled to a finger light housing.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

The present invention relates to illumination devices and more particularly to a finger light that provides illumination adjacent to a finger to which it is attached, particularly for writing and illuminating such writing.

2. Description of the Related Art

Without proper illumination during a writing activity, many individuals find it difficult to operate in such environment. Various portable lighting sources are known in the art and include flashlights, lamps, and other lighting structures which are generally operated electrically and controlled by a switch.

There are times when only a small amount of light is necessary as when it is important to diminish any disturbance to others, operate with discretion and possible secrecy, and otherwise. To this end, a variety of finger lights have been developed as well as other manually operated and manually attached portable lighting devices. None of these devices are adapted for easy conversion to a portable magnifying light source that can be used for local illumination.

### SUMMARY OF THE INVENTION

The present invention provides a finger light configuration that can be used for illuminating writing among other things.

The general purpose of the present invention, which will be described subsequently in greater detail, is to provide a new finger light which has many of the advantages of the finger lights known heretofore and many novel features that result in a finger light which is not anticipated, rendered obvious, suggested, taught, or even implied by any of the prior art finger lights, either alone or in any combination thereof.

The housing provides an enclosure for a light source and a replaceable power source. The light source may be a LED (Light Emitting Diode). The replaceable power source may be button cell batteries. The circuit between the batteries and the LED may be controlled by a switch, all of which may be contained in the housing. The switch may protrude from the housing for operation. A finger-engaging section may be removed or re-coupled to the switchable light source with its housing. A finger-engaging portion provides means by which removable engagement with the finger may occur with respect to the switchable light source.

By optional removal of the finger-engaging framework, a magnifying section may also be removably attached to the top of the housing and the switchable light source. The removable magnifying section may include an extension that spaces a lens or other magnifying device away from the front of the switchable light source to thereby enable illumination of an area generally beneath the lens.

The magnifying extension and the finger-engaging framework may be used separately or together. Optional detents may provide for adjustment of the finger-engaging portion with respect to its disposition relative to the housing of the switchable light source. The same or similar adjustment means may be present with respect to the magnifying extension.

In one embodiment, a finger light for local illumination adjacent a finger has a switchable light source sized for easy carrying by a finger between the first and second knuckle of the finger. The switchable light source transmits light downwardly relative to a main axis of the switchable light source at a forward end thereof. A removable finger-engaging section is removably coupled to the switchable light source and is adapted for engaging the finger between the first and second knuckle. In this way, the finger light is easily engageable by the finger and the finger light generally does not interfere with manual activities including the holding of a writing instrument and writing with the writing instrument.

In another embodiment, a magnifying light for local illumination of relatively small objects or relatively small portions of objects has a switchable light source generally sized for easy carrying by a finger between the first and second knuckle of the finger. The switchable light source transmits light downwardly relative to a main axis of the switchable light source at a forward end thereof. A removable magnification section is removably coupled to the switchable light source and is adapted for magnifying an area illuminated by the switchable light source. In this way, an area or object may be illuminated and magnified for better visual inspection.

In accordance with one aspect of the invention, a finger light comprises at least one LED (Light Emitting Diode) adapted for local illumination, at least one button cell adapted for use as a power source for the LED, wherein the button cell is operatively coupled between the LED and an electrical switch, and a housing adapted to operatively accommodate the LED, button cell and electrical switch. The finger light also comprises a framework adapted to engage at least one finger of a user's hand. The framework includes at least one channel configured to receive at least a portion of the housing. The LED within the received housing casts a light beam proximate to the tip of a writing instrument being used during a writing activity.

In accordance with another aspect of the invention, a magnifying light for local illumination comprises at least one LED adapted for use as a finger light source, at least one button cell adapted for use as a power source for the LED, wherein the button cell is operatively coupled between the LED and an electrical switch, and a finger light housing adapted to operatively accommodate the LED, button cell and electrical switch. The magnifying light also comprises at least one magnifying lens being disposed in operative proximity to the LED, and a lens chassis adapted to accommodate the magnifying lens such that the focus area of the magnifying lens substantially corresponds with the local area being illuminated by the LED. The lens chassis includes a channel section configured to receive at least one portion of the finger light housing. The channel section is adapted to allow slidable positional adjustment of the received finger light housing.

These and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a side perspective view of a person's hand with a writing implement and a finger light being used in accordance with the present invention;

FIG. 2 is an exploded perspective view of the finger light of FIG. 1;

FIG. 3 is a bottom perspective view of the finger light of FIG. 2 in assembled form;

FIG. 4 is a bottom perspective view of a magnifying light adapted for local illumination in accordance with the present invention;

FIG. 5 is an exploded perspective view of the magnifying light of FIG. 4; and

FIG. 6 is a top perspective view of the magnifying light of FIG. 4.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the present invention.

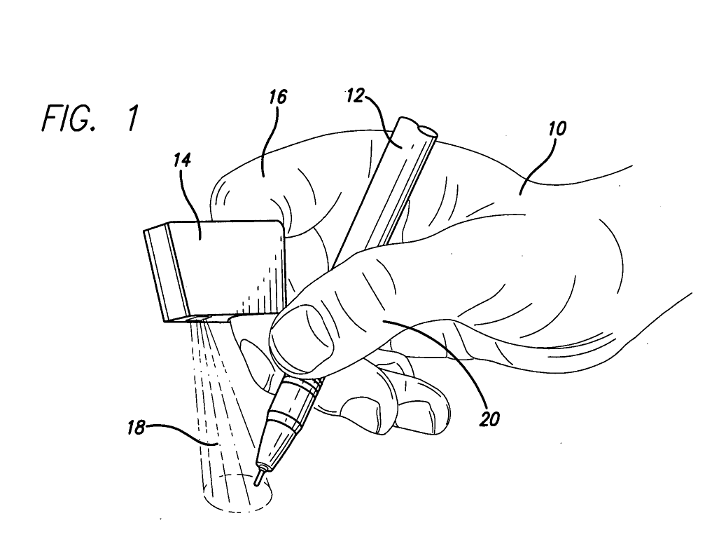

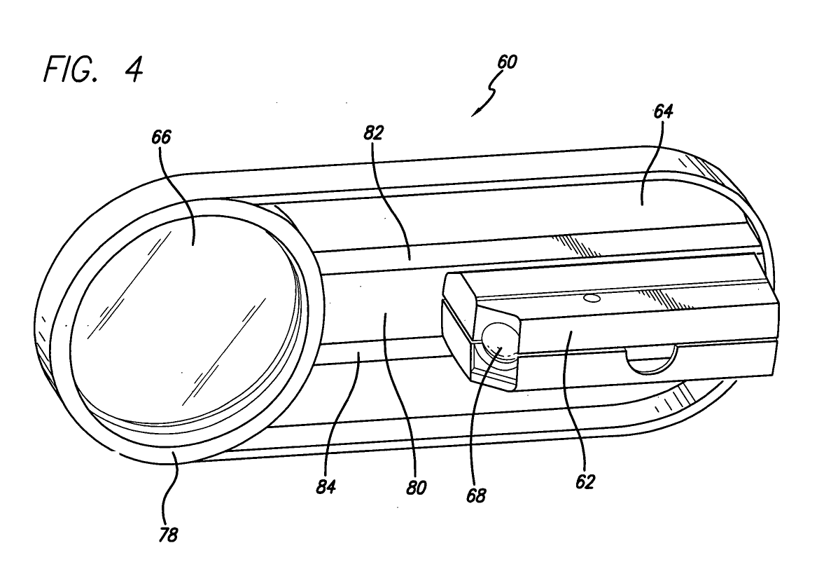

Some embodiments of the present invention will be described in detail with reference to a finger light, as generally shown in FIGS. 1-3. Other embodiments of the present invention will be described in detail with reference to a magnifying light adapted for local illumination, as generally shown in FIGS. 4-6. Additional embodiments, features and/or advantages of the invention may become apparent from the ensuing description or may be learned by practicing the invention. In the figures, the drawings are not to scale with like numerals referring to like features throughout both the drawings and the description.

FIG. 1 is a side perspective view of a user's hand 10 with a writing implement 12 and a finger light 14 being used in accordance with the present invention. Finger light 14 is removably attached to a forefinger 16 so that a light beam 18 may be cast in proximity to the tip of writing implement 12 to provide local illumination for the user during a writing activity. Writing implement 12 is being held in place by a thumb 20.

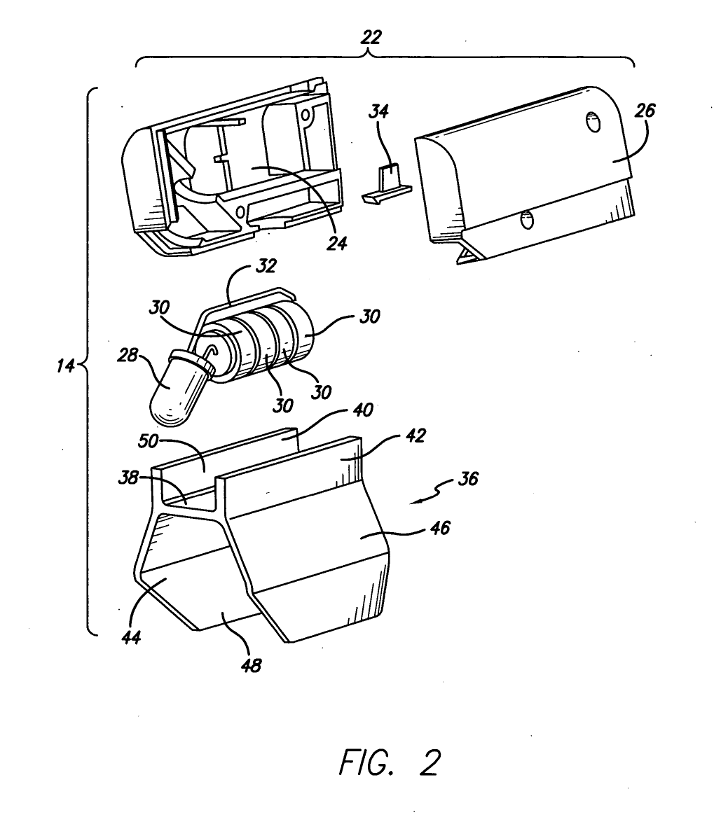

FIG. 2 is an exploded perspective view of finger light 14. Specifically, finger light 14 includes a housing 22 which has a right side 24 and a left side 26 that are adapted to mate together and provide internal structure or chassis for a light source 28 and associated power supply 30 and electrical conductor 32. In one embodiment, light source 28 may be a LED suitable for local illumination in conjunction with writing activity. In another embodiment, power supply 30 may be implemented as four button cells operatively connected in series between LED 28 and associated electrical switch 34. Other suitable implementations may be utilized, as needed.

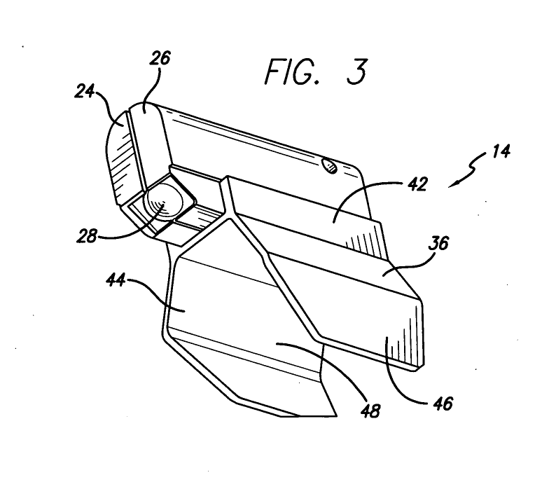

Finger light 14 further includes a finger-engaging framework 36 adapted to removably couple housing 22 to forefinger 16 (FIG. 1). Finger-engaging framework 36 includes a center panel 38 disposed between a right side retaining panel 40 and a left side retaining panel 42. Right and left side retaining panels 40, 42 generally span the entire length of center panel 38 and are adapted to frictionally engage the bottom portion of housing 22, as generally depicted in FIG. 3.

Descending from center panel 38 are two oppositely disposed (right and left) wings 44, 46 configured to frictionally engage and capture forefinger 16 (FIG. 1) as it is slid into a channel 48 being generally defined between wings 44, 46. With forefinger 16 captured within channel 48, finger light 14 may be worn thereon like a ring between the first and second knuckles of forefinger 16. Switch 34 may then be engaged to close the circuit between LED 28 and button cells 30 and allow for illumination of a local area during writing or reading activity. Other fingers of user's hand 10 may be utilized, as needed. Each wing (44, 46) and each retaining panel (40, 42) are configured with a certain degree of flexibility to allow engagement and release of corresponding structure.

FIG. 3 is a bottom perspective view of finger light 14 in assembled form. A person skilled in the art would appreciate that detents may be used optionally to provide a degree of adjustment between finger-engaging framework 36 and the bottom portion of housing 22. Other devices may be used to provide some slidable adjustment between finger-engaging framework 36 and housing 22 as housing 22 slides within channel 50 (FIG. 2) that is generally defined between center panel 38 and housing retaining panels 40, 42 during engagement thereto.

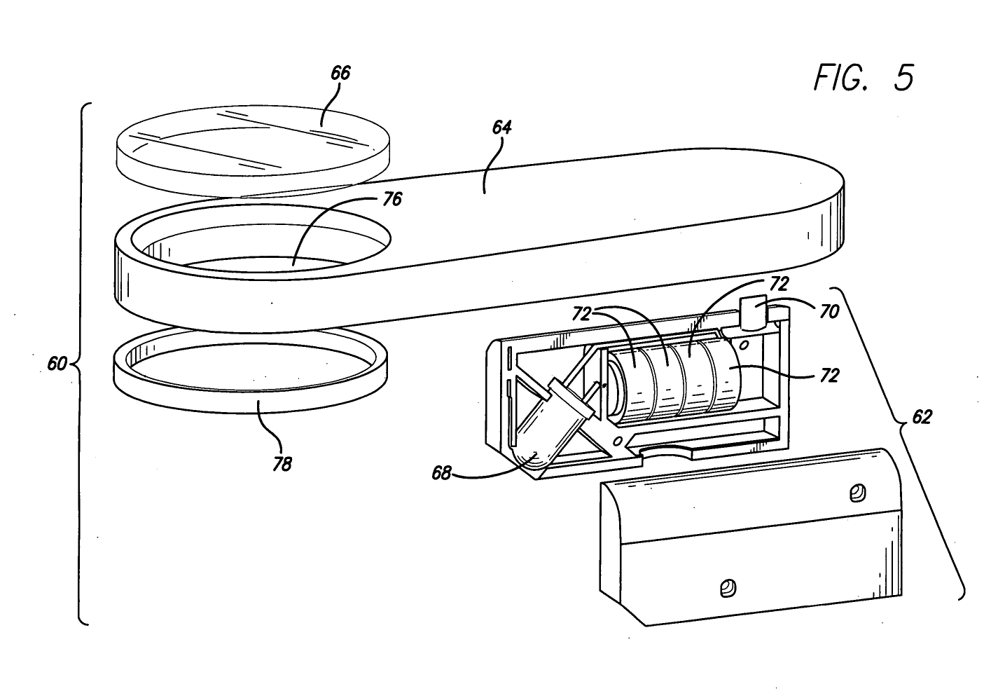

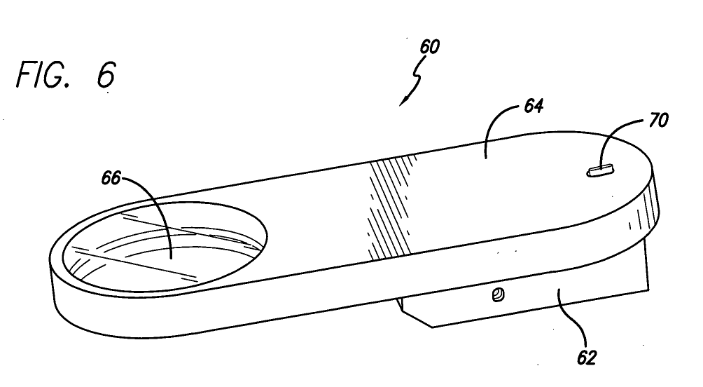

FIG. 4 is a bottom perspective view of a portable magnifying light 60 adapted for local illumination in accordance with the present invention. Portable magnifying light 60 includes a finger light housing 62 operatively coupled to a lens chassis or magnification section 64. Lens chassis 64 is adapted to accommodate a magnifying lens 66 at a distal end thereof, as generally depicted in FIG. 5. Finger light housing 62 includes a suitable light source 68 at a front end thereof (FIG. 4). Magnifying lens 66 projects generally away from the front end of finger light housing 62 so that the focus area of lens 66 generally corresponds with the local area being illuminated by light source 68. Light source 68 may be a LED or the like, as needed. Light source 68 may be turned on/off via an integral electrical switch 70 (FIGS. 5-6).

FIG. 5 is an exploded perspective view of magnifying light 60. Finger light housing 62 is constructed generally in the same manner as housing 22 of finger light 14 of FIG. 2. Specifically, finger light housing 62 is adapted to accommodate four button cells 72 which are operatively coupled between LED 68 and integral light switch 70 (FIGS. 5-6). Button cells 72 provide power to LED 68. Lens chassis 64 includes an aperture 76 at a distal end thereof that is adapted to provide a seat for magnifying lens 66. Lens 66 is held frictionally therein via a generally ring-shaped lens frame 78. A person skilled in the art would appreciate that lens 66 may also be held via snap action, adhesion or the like.

Portable magnifying light 60 may be easily constructed by removing finger-engaging framework 36 from housing 22 of finger light 14 and attaching the stand-alone finger light housing to a raised bottom channel section 80 of lens chassis 64. Bottom channel section 80 is defined between two ribs 82, 84 (FIG. 4) which project generally away from the bottom surface of lens chassis 64. Bottom channel section 80 may be configured to allow slidable positional adjustment of finger light housing 62 therein, as needed by the user. Lens chassis 64 is adapted to accommodate light switch 70, as generally illustrated in FIG. 6. Magnification of object(s) illuminated by LED 68 occurs when observation is made through lens 66.

The finger light of the present invention may be adapted for attachment to a writing instrument, such as a pen, pencil and the like. Other suitable design configurations may be utilized as needed. The exemplary embodiments described hereinabove are merely illustrative of the general principles of the present invention. Various design modifications may be employed that would reside within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed is:

1. A finger light for local illumination adjacent a finger, the finger light comprising:
a switchable light source sized for easy carrying by a finger between the first and second knuckles of the finger, said switchable light source transmitting light downwardly relative to a main axis of said switchable light source at a forward end thereof; and
a removable finger-engaging section removably couplable to said switchable light source and adapted for engaging the finger between the first and second knuckles, whereby the finger light is easily engageable by the finger, the finger light generally not interfering with manual activities including holding a writing instrument and writing with the writing instrument.

2. The finger light of claim 1, wherein said switchable light source comprises:
a disassemblable housing defining a forward aperture disposed at a generally positive downward angle with respect to said main axis;
a light removably disposed in said forward aperture;
a replaceable power source coupled to said light; and
a switch controllably completing a circuit between said light and said power source; whereby
said light shines downwardly with respect to said housing when said switch completes said circuit so that light emitted by said light advantageously illuminates an area proximate the finger.

3. The finger light of claim 2, wherein said housing has two generally symmetrical halves engaging one another to secure said light and said replaceable power source therewithin and to provide a coupling for said switch so that said switch may operate to control said light.

4. The finger light of claim 3, wherein said light is a LED (Light Emitting Diode) and said replaceable power source includes at least one battery.

5. The finger light of claim 1, wherein said removable finger-engaging section comprises a framework having first and second open ends, said first end engaging said switchable light source and said second end engaging the finger whereby said framework removably couples said switchable light source to the finger.

6. The finger light of claim 5, wherein said first open end is defined by first and second oppositely opposed retaining elements for engaging and retaining said switchable light source, and said second open end is defined by first and second oppositely opposed wings for engaging and retaining the finger.

7. The finger light of claim 6, wherein said first wing is configured as an angled panel adapted to engage one side of the finger, and said second wing is configured as a mirror image of said first wing.

8. A finger light for local illumination adjacent a finger, the finger light comprising:
a switchable light source comprising a LED (Light Emitting Diode) and sized for easy carrying by a finger between the first and second knuckle of the finger, said switchable light source transmitting light downwardly relative to a main axis of said switchable light source at a forward end thereof,
said switchable light source having a disassemblable housing defining a forward aperture disposed at a generally positive downward angle with respect to said main axis, a light removably disposed in said forward aperture, a replaceable power source comprising at least one battery coupled to said light, and a switch controllably completing a circuit between said light and said power source such that said light shines downwardly with respect to said housing when said switch completes said circuit so that light emitted by said light advantageously illuminates an area proximate the finger,
said housing having two generally symmetrical halves engaging one another to secure said light and said replaceable power source therewithin and to provide a coupling for said switch so that said switch may operate to control said light;
a removable finger-engaging section removably couplable to said switchable light source and adapted for engaging the finger between said first and second knuckle,
said removably finger-engaging section including a framework defining first and second open ends, said first end engaging said switchable light source and said second end engaging the finger whereby said framework removably couples said switchable light source to the finger,
said first open end defined by first and second oppositely opposed retaining elements for engaging and retaining said switchable light source,
said second open end defined by first and second oppositely opposed wings for engaging and retaining the finger,
said first wing being an angled panel adapted to engage one side of the finger; and
a second wing being a mirror image of said first wing, whereby the finger light is easily engageable and disengageable by the finger, the finger light generally not interfering with manual activities including holding a writing instrument and writing with the writing instrument.

9. A magnifying light for local illumination of relatively small objects or relatively small portions of objects, the magnifying light comprising:
a switchable light source generally sized for easy carrying by a finger between the first and second knuckle of the finger, said switchable light source transmitting light downwardly relative to a main axis of said switchable light source at a forward end thereof; and
a removable magnification section removably couplable to said switchable light source and adapted for magnifying an area illuminated by said switchable light source, whereby an area or object may be illuminated and magnified for better visual inspection.

10. The magnifying light of claim 9, wherein said switchable light source comprises:
a disassemblable housing defining a forward aperture disposed at a generally positive downward angle with respect to said main axis;
a light removably disposed in said forward aperture;
a replaceable power source coupled to said light; and
a switch controllably completing a circuit between said light and said power source, whereby said light shines downwardly with respect to said housing when said switch completes said circuit so that light emitted by said light advantageously illuminates an area proximate the finger.

11. The magnifying light of claim 10, wherein said housing has two generally symmetrical halves engaging one another to secure said light and said replaceable power source therewithin and to provide a coupling for said switch so that said switch may operate to control said light.

12. The magnifying light of claim 11, wherein said light is a LED and said replaceable power source includes at least one battery.

13. The magnifying light of claim 9, wherein said removable magnification section comprises:
an extension removably coupleable to said switchable light source; and
a lens structure coupled to said extension and positioned generally forward of said switchable light source.

14. The magnifying light of claim 13, wherein said extension defines an aperture, said lens structure having a lens and a lens ring, said lens disposed in said aperture and said lens ring positioned adjacent said lens and holding said lens in position with respect to said extension.

15. A magnifying light for local illumination of relatively small objects or relatively small portions of objects, said magnifying light comprising:
a switchable light source generally sized for easy carrying by a finger between the first and second knuckle of the finger, said switchable light source transmitting light downwardly relative to a main axis of said switchable light source at a forward end thereof, said switchable light source having:
a disassemblable housing defining a forward aperture disposed at a generally positive downward angle with respect to said main axis;
a light removably disposed in said forward aperture and including a LED light;
a replaceable power source coupled to said light and including at least one battery; and
a switch controllably completing a circuit between said light and said power source such that said light shines downwardly with respect to said housing when said switch completes said circuit so that light emitted by said light advantageously illuminates an area proximate the finger, said housing having two generally symmetrical halves engaging one another to secure said light and said replaceable power source therewithin and to provide a coupling for said switch so that said switch may operate to control said light;
a removable magnification section removably couplable to said switchable light source and adapted for magnifying an area illuminated by said switchable light source such that an area or object may be illuminated and magnified for better visual inspection, said removable magnification section having an extension removably coupleable to said switchable light source and having a lens structure coupled to said extension and positioned generally forward of said switchable light source, said extension defining an aperture and said lens structure having a lens and a lens ring, said lens disposed in said aperture and said lens ring positioned adjacent said lens and holding said lens in position with respect to said extension.

16. The magnifying light of claim 15, further comprising a removable finger-engaging section removably couplable to said switchable light source and adapted for engaging the finger between said first and second knuckle, whereby the finger light is easily engageable by the finger, the finger light generally not interfering with manual activities including holding a writing instrument and writing with said writing instrument.

17. A finger light, comprising:
at least one LED (Light Emitting Diode) adapted for local illumination;
at least one button cell adapted for use as a power source for said at least one LED, said at least one button cell being operatively coupled between said at least one LED and an electrical switch;
a housing adapted to operatively accommodate said at least one LED, said at least one button cell and said electrical switch; and
a framework adapted to engage at least one finger of a user's hand, said framework including at least one channel configured to receive at least a portion of said housing, said at least one LED within said received housing casting a light beam proximate to the tip of a writing instrument being used during a writing activity.

18. A magnifying light for local illumination, comprising:
at least one LED (Light Emitting Diode) adapted for use as a finger light source;
at least one button cell adapted for use as a power source for said at least one LED, said at least one button cell being operatively coupled between said at least one LED and an electrical switch;
a finger light housing adapted to operatively accommodate said at least one LED, said at least one button cell and said electrical switch;
at least one magnifying lens being disposed in operative proximity to said at least one LED; and
a lens chassis adapted to accommodate said at least one magnifying lens such that the focus area of said at least one magnifying lens substantially corresponds with the local area being illuminated by said at least one LED, said lens chassis including a channel section configured to receive at least one portion of said finger light housing, said channel section adapted to allow slidable positional adjustment of said received finger light housing.
